(19) United States
(12) Patent Application Publication
(10) Pub. No.: US 2009/0259587 A1
(43) Pub. Date: Oct. 15, 2009

(54) Commissions Futures Trading

(76) Inventor: Shlomo Shnieberg, Elkana (IL)

Correspondence Address: FISH & RICHARDSON P.C., P.O. BOX 1022, MINNEAPOLIS, MN, 55440-1022, US

(21) Appl. No.: 12/103,466

(22) Filed: Apr. 15, 2008

(51) Int. Cl. G06Q 40/00

(52) U.S. Cl. 705/39

(57) ABSTRACT

Implementing a method for trading commissions includes purchasing an expected commission payment from a real-estate agent or real-estate brokerage firm in exchange for a payment of funds to the real-estate agent or the real-estate brokerage firm. The expected commission payment is associated with a real-estate transaction. Funds are transferred in exchange for the expected commission payment. The right to the funds is not conditioned on completion of the real-estate transaction.

### TECHNICAL FIELD

This disclosure relates to commissions futures trading.

### BACKGROUND

Typically, a sales transaction is initiated and completed within a brief period of time (e.g., within an hour). After the sale is completed, the salesperson receives credit for the sale price and receives a percentage of the sale price as a commission in the salesperson's next paycheck. The salesperson has a right to the commission because the sales transaction is completed.

In some industries, the amount of time elapsed between the sale being initiated and completed is considerably longer than one hour and can be several months. For example, a real-estate agent/broker may initiate the sale of a real property (e.g., a down payment is made) and the sale will not be completed until the closing (i.e., when the title is transferred and the balance of the sale price is paid). In this case, the real-estate agent/broker does not have a right to the commission until the sale is completed. Instead, the real-estate agent/broker has an expected commission which is a future asset that the salesperson owns. The expected commission is realized when the sale is completed which gives the real-estate agent/broker a right to the commission. After the real estate agent/broker has a right to the commission, the commission is referred to as the realized commission.

### SUMMARY

The details of one or more implementations of the invention are set forth in the accompanying drawings and the description below.

In one aspect, implementing a method for trading commissions includes purchasing an expected commission payment from a real-estate agent in exchange for a payment of funds to the real-estate agent. The expected commission payment is associated with a real-estate transaction. Funds are transferred to the real-estate agent in exchange for the expected commission payment. The real-estate agent's right to the funds is not conditioned on completion of the real-estate transaction.

In another aspect, implementing a method for trading commissions includes purchasing an expected commission payment from a real-estate brokerage firm in exchange for a payment of funds to the real-estate brokerage firm. The expected commission payment is associated with a real-estate transaction. Funds are transferred to the real-estate brokerage firm in exchange for the expected commission payment. The real-estate brokerage firm's right to the funds is not conditioned on completion of the real-estate transaction

The method for trading commissions can be extended to other commission based industries such as advertising sales and television commercial sales.

The details of one or more embodiments of the invention are set forth in the accompanying drawings and the description below. Various features and advantages of the invention will be apparent from the description and drawings, and from the claims.

### BRIEF DESCRIPTION OF DRAWINGS

FIG. 1 is a flowchart illustrating an example process to trade real-estate commissions.

FIG. 2 is a flowchart illustrating an example process to trade real-estate commissions online.

FIG. 3 is a flowchart illustrating an example process to trade real-estate commissions.

FIG. 4 is a block diagram of an example system implementing an online real-estate commission trading system.

### DETAILED DESCRIPTION

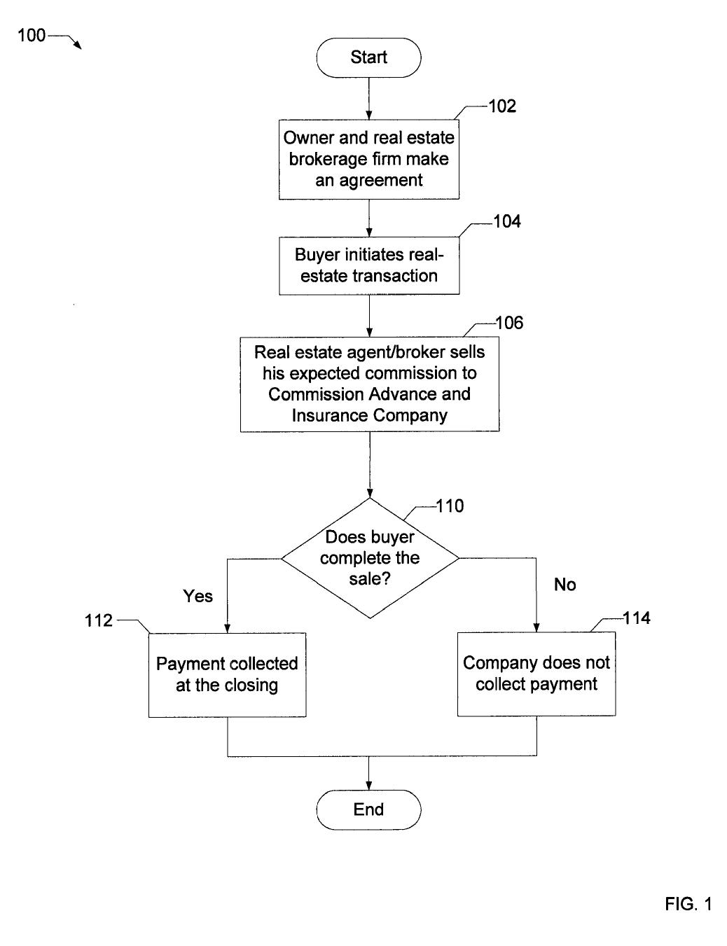

FIG. 1 illustrates an example process 100 for trading real-estate commissions. Process 100 begins when an owner of real estate agrees to use a real-estate brokerage firm to help sell the property owner's real property (block 102). In other implementations, the owner of real estate may use the real-estate brokerage firm to help lease the real property. The property owner and the real-estate brokerage firm typically enter an agreement that entitles the real-estate brokerage firm to a percentage of the sale price (i.e., the brokerage's commission) after the property is sold. The property owner interacts with a real-estate agent who works for or is associated with the real-estate brokerage firm. The real-estate agent/broker (i.e., the real estate agent or the real estate brokerage firm) then markets the real property and makes efforts to sell the real property. The property can be, for example, a single family house, a condominium, a townhouse, commercial real-estate, or some other form of real property. For ease of discussion, the property will be referred to as a real property in the following example.

Process 100 continues when a buyer is interested in purchasing the real property and initiates the real-estate transaction (block 104). In some implementations, the real-estate transaction can be initiated when the buyer makes a down payment to the property owner which can be equal to a percentage of the sale price such as 10%. In other implementations, the buyer can initiate the sale of real property without making a down payment. For example, the sale of a real property can be initiated by signing a contract to purchase the real property or a document indicating the buyer's intent to purchase the real property.

After the sale of the real property is initiated, the real-estate agent earns an expected commission from the real-estate brokerage firm which is a percentage of the brokerage firm's expected commission. In some implementations, the laws of the local jurisdiction determines if the property owner or the real-estate brokerage firm pays the real-estate agent/broker's expected commission.

The real-estate agent then approaches a commission advance and insurance company to sell his expected commission, which is a future asset owned by the real-estate agent/broker (block 106). Alternatively, the real estate brokerage firm can approach the commission advance and insurance company to sell its expected brokerage commission.

In some implementations, the commission advance and insurance company offers an amount of money (i.e., a commission purchase price) that is less than the realized commission. The commission advance and insurance company can calculate the amount it will pay the real-estate agent/broker for the expected commission based on several different factors. In some implementations, the factors include current interest rates, current inflation rates, amount of time until closing, discount cash flow models, assessments of risk and local property sales trends. For example, the commission advance and insurance company might calculate that the commission purchase price is $850 for a $1000 expected commission because the closing date is more than six months in the future and the inflation rate is high.

The commission advance and insurance company then pays the real-estate agent/broker the commission purchase price. This allows the real-estate agent/broker to collect money immediately instead of waiting for the sale to be completed. After paying the real-estate agent/broker, the commission advance and insurance company owns the agent/broker's expected commission and is entitled to recover the realized commission when the sale is completed. If the sale of the real property is not completed (e.g., the buyer decides not to pay the balance of the sales price), the real-estate agent/broker is not responsible for repaying the commission purchase price the real-estate agent/broker received because the commission purchase price is not a loan. Instead, it is a sale of a future asset. In addition, the commission advance and insurance company has no rights against the real-estate agent/broker if the sale of the home is not completed.

In some implementations where the real-estate brokerage firm sells its expected commission, the commission advance and insurance company can notify the property owner that the brokerage firm has sold its expected commission and that payment of the realized commission should be made directly to the commission advance and insurance company. In other implementations where the real-estate brokerage firm sells its expected commission, the commission advance and insurance company can collect the realized commission from the brokerage firm after the brokerage firm receives the realized commission.

In some implementations where a real estate agent sells his expected commission, the commission advance and insurance company can collect the realized commission from the agent, from the brokerage firm he works for or from the property owner. In other implementations where a real-estate brokerage firm sells their expected commission, the commission advance and insurance company can collect the realized commission from the brokerage firm or from the property owner

The commission advance and insurance company then waits for the sale of the property to be completed (block 110). If the sale is completed, the commission advance and insurance company collects the realized commission (block 112). In some implementations, the commission advance and insurance company can collect the realized commission from the real-estate agent/broker. Alternatively, the real-estate brokerage firm pays the realized commission to the commission advance and insurance company directly.

In other implementations, the laws of the jurisdiction or the agreement between the real-estate brokerage firm arid the property owner provide that the property owner pays the realized commission directly to the commission advance and insurance company. Alternatively, the commission advance and insurance company collects the realized commission from the brokerage firm.

If the sales contract is revoked and void, then the commission advance and insurance company suffers an economic loss because the expected commission does not mature and become a realized commission (i.e., the asset has no value) (block 114). This risk of economic loss, however, can be factored into the commission purchase price which allows the commission advance and insurance company to pay the real estate-agent/broker commission purchase price that is less than the expected commission and is less than an amount the real estate agent/broker may otherwise receive for his expected commission (i.e., a price a typical commission advance company would pay). The commission advance and insurance company pays the real-estate agent/broker a commission purchase price that is less than the real-estate agent/broker may receive from typical commission advance companies because it bears the risk of not receiving the realized commission if the sale is not completed.

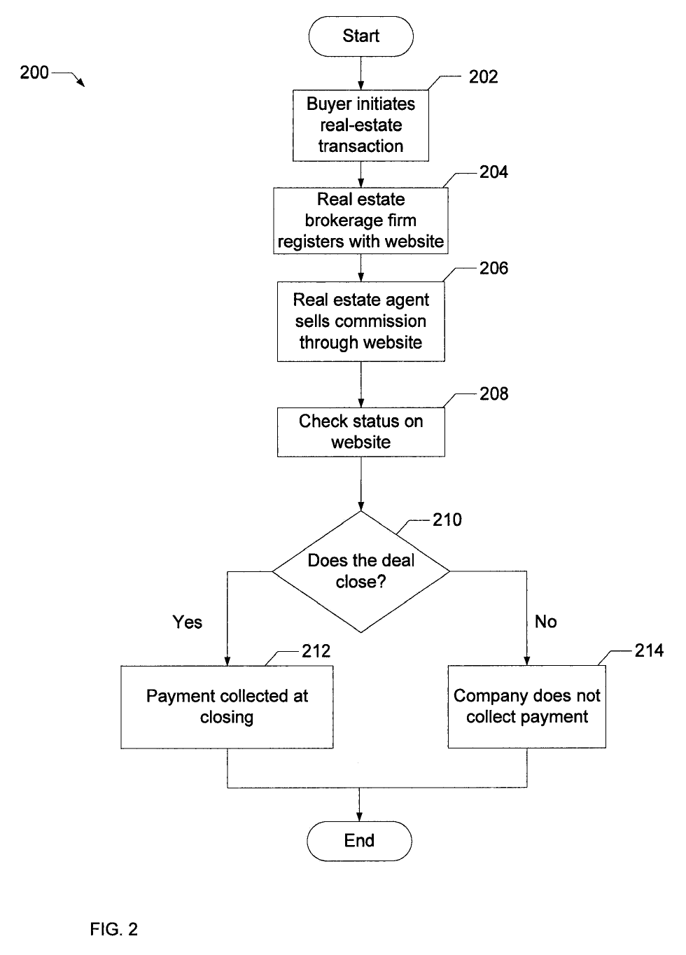

In some implementations, process 100 can be modified to include a computer or an Internet website. For example, as shown in FIG. 2, process 200 illustrates an example process for trading real-estate commissions online. Similar to process 100 described above, the real-estate brokerage firm and the property owner have an agreement that the property owner will pay a brokerage commission after the property is sold or leased. The process 200 continues when a buyer initiates the sale of the (block 202). The real-estate brokerage firm registers with a website associated with the commission advance and insurance company (block 204). The registration process allows real-estate agents associated with the real-estate brokerage firm to create accounts with the website and to sell their expected commissions. Alternatively, the registration process allows the real-estate brokerage firm to create an account with the website and to sell its expected brokerage commission. The registration process can include creating an account associated with the real-estate brokerage firm, creating accounts associated with each real-estate agent associated with the real-estate brokerage firm, providing financial information and agreeing to user terms of the website. In other implementations, the property owner can register with the website.

The real-estate agent/broker then logs into the website and initiates the sale of his expected commission by providing information to the website (block 206). In one implementation, the real-estate agent/broker enters information such as the date of the closing, the sale price for the home, the address of the home and the amount of the expected commission. The website then calculates the commission purchase price. The website can calculate the commission purchase price using factors similar to those described above in the discussion of process 100.

The website can provide information related to the status of the sales transaction. For example, the website will give an up-to-date status messages (block 208). Example status messages include:
Registration with the website.
Sale initiated of a real property by brokerage firm or real estate agent.
Case assigned.
Case under evaluation of commission.
Case approved.
Commission sales pending.
Contact review pending.
Contact reviewed.
Payment pending.
Commission advance paid.

In some implementations, the website can notify the real-estate brokerage firm that the real-estate agent has sold his expected commission. In some implementations, the notification can be an e-mail or a message sent to the real-estate brokerage firm. In other implementations, the website notifies the property owner that the real-estate agent/broker has sold his commission. In some implementations website is used as a database search engine to locate a brokerage firm or a agent.

The commission advance and insurance company waits until the sale is completed to collect payment(block 210). The payment to the agent/broker can be made by an electronic transfer of funds, a check, or some other method of payment. If the sale is not completed, the commission advance and insurance company suffers an economic loss similar to process 100.

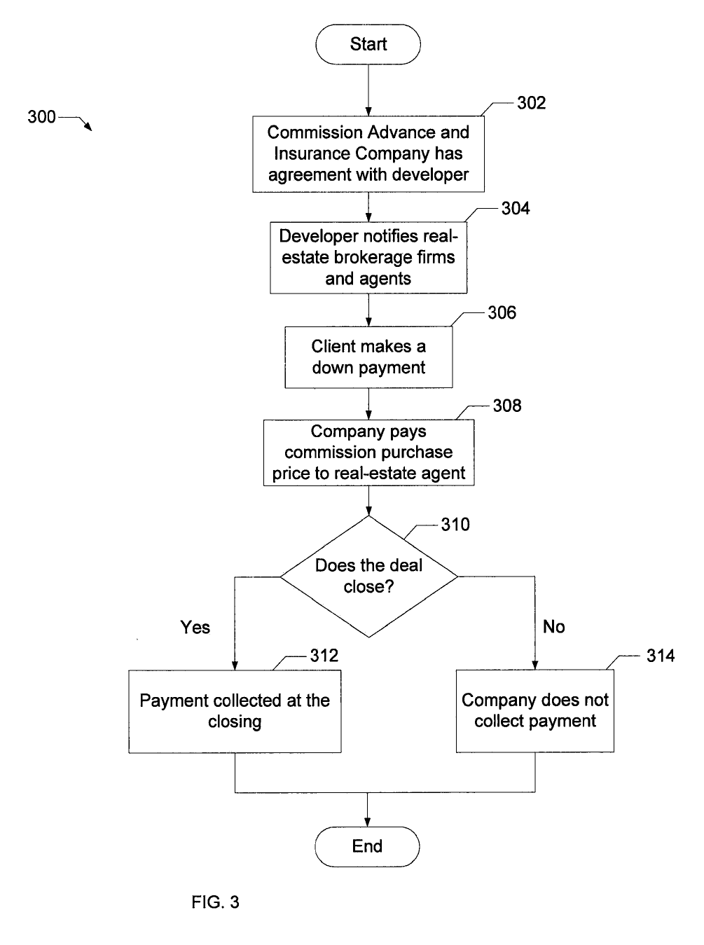

FIG. 3 illustrates another example process 300 for trading real-estate commissions. Process 300 begins when the commission advance and insurance company and a real-estate developer agree that the commission advance and insurance company will pay a commission purchase price to each real-estate agent or real-estate brokerage firm when a real-estate transaction is initiated, if the real-estate agent or real-estate brokerage firm choose to use the offered services of the commission advance and insurance company (block 302).

The commission advance and insurance company can calculate the commission purchase price using factors similar to those described above in the discussion of process 100. The developer then notifies real-estate brokerage firms and real-estate agents that a commission purchase price will be paid to each real-estate agent or real-estate brokerage firm when the sale of a real property is initiated (block 304).

If a real-estate agent/broker decides to work with the developer, the real-estate agent/broker shows its clients properties built by the developer until a property-transaction is initiated (e.g., when a down payment is made) (block 306). The commission advance and insurance company then pays the real-estate agent/broker the commission purchase price (block 308). As described above, the payment is not a loan and is a sale of a future asset (i.e., the expected commission). As a result, the real-estate brokerage firm or the real-estate agent do not have to repay the money if the property-transaction is cancelled and void.

The commission advance and insurance company then waits until the property-transaction is completed (block 310). When the transaction is completed the commission advance and insurance company collects the realized commission from the developer (block 312). If the sale is not cancelled and void, the commission advance and insurance company suffers an economic loss (block 314). As described above, the risk of economic loss can be factored into the commission purchase price.

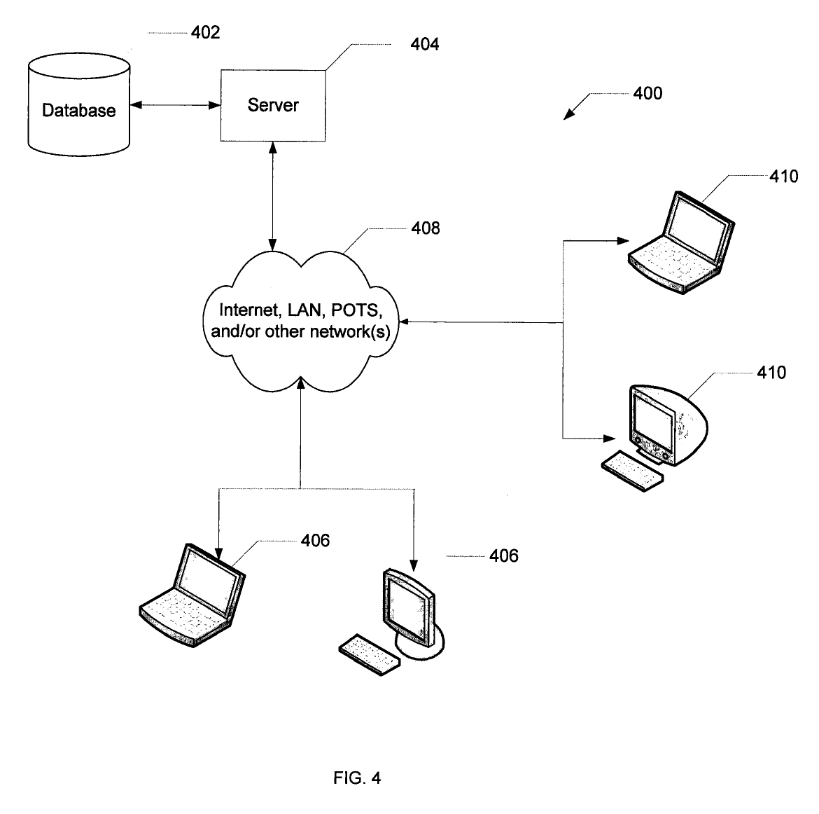

FIG. 4 illustrates an example system that can be used to implement an online real-estate commission trading system 400. The example online real-estate commission trading system 400 includes one or more databases 402 connected to a server 404. The server 404 can be, but is not limited to, any type of dedicated server or personal computer. The database 402 can be contained within the server 404 or can be in a separate storage device or computer. The database 402 can be used to store accounts associated with the real-estate agent/broker, the property owner, and the real-estate brokerage firm.

The server 404 can exchange data with other computing devices 406 via a connection to a communication network 408. The network connection may be any type of network connection, such as an Ethernet connection, digital subscriber line (DSL), telephone line or coaxial cable. The communication network 408 can be any type of network, such as the Internet, a telephone network, a cable network or a wireless network. The computing device 406 can be any type of computing device. For example, the computing device 406 can be a personal computer, a laptop or a personal digital assistant (“PDA”). The communication network 408 can transmit information from the server 404 to the computing devices 406 or can transmit information from the computing devices 406 to the server 404.

A number of implementations of the invention have been described. Nevertheless, it will be understood that various modifications may be made without departing from the spirit and scope of the invention. For example, the commission advance and insurance company and the real-estate brokerage firm can be part of the same entity. Accordingly, other embodiments are within the scope of the following claims

What is claimed is:

1. A method for trading commissions comprising:
purchasing an expected commission payment from a real-estate agent in exchange for a payment of funds to the real-estate agent, wherein the expected commission payment is associated with a real-estate transaction; and
transferring funds to the real-estate agent in exchange for the expected commission payment, wherein the real-estate agent's right to the funds is not conditioned on completion of the real-estate transaction.

2. The method of claim 1 further comprising calculating a commission purchase price before purchasing the expected commission payment.

3. The method of claim 2 wherein the commission purchase price is based on a discount cash flow model.

4. The method of claim 1 wherein the amount of funds transferred to the real-estate agent is equal to the commission purchase price.

5. The method of claim 2 wherein the commission purchase price is less than the expected commission payment.

6. The method of claim 1 further comprising receiving a realized commission payment after the real-estate transaction is completed.

7. The method of claim 6 wherein a real-estate brokerage firm transfers the realized commission payment.

8. The method of claim 6 wherein the real-estate agent transfers the realized commission payment.

9. The method of claim 6 wherein a real-estate developer transfers the realized commission payment.

10. The method of claim 6 wherein an owner of property involved in the real-estate transaction transfers the realized commission payment

11. A method for trading commissions comprising:
purchasing an expected commission payment from a real-estate brokerage firm in exchange for a payment of funds to the real-estate brokerage firm, wherein the expected commission payment is associated with a real-estate transaction; and
transferring funds to the real-estate brokerage firm in exchange for the expected commission payment, wherein the real-estate brokerage firm's right to the funds is not conditioned on completion of the real-estate transaction.

12. The method of claim 11 further comprising calculating a commission purchase price before purchasing the expected commission payment.

13. The method of claim 12 wherein the commission purchase price is based on a discount cash flow model.

14. The method of claim 11 wherein the amount of funds transferred to the real-estate brokerage firm is equal to the commission purchase price.

15. The method of claim 12 wherein the commission purchase price is less than the expected commission payment.

16. The method of claim 11 further comprising receiving a realized commission payment after the real-estate transaction is completed.

17. The method of claim 16 wherein the real-estate brokerage firm transfers the realized commission payment.

18. The method of claim 16 wherein an owner of property involved in the real-estate transaction r transfers the realized commission payment.

19. The method of claim 16 wherein a real-estate developer transfers the realized commission payment.

20. A machine implemented method for trading commissions online comprising:
creating an account for a real-estate agent;
purchasing an expected commission payment from the real-estate agent in exchange for a payment of funds to the real-estate agent, wherein the expected commission payment is associated with a real-estate transaction; and
transferring funds to the real-estate agent in exchange for the expected commission payment, wherein the real-estate agent's right to the funds is not conditioned on completion of the real-estate transaction.

21. The method of claim 20 further comprising:
receiving information associated with the real-estate transaction; and
calculating a commission purchase price before purchasing the expected commission payment.

22. The method of claim 21 wherein the commission purchase price is based on a discount cash flow model.

23. The method of claim 20 further comprising receiving a realized commission payment after the real-estate transaction is completed.

24. The method of claim 23 wherein a real-estate brokerage firm transfers the realized commission payment.

25. The method of claim 23 wherein the real-estate agent transfers the realized commission payment.

26. The method of claim 23 wherein a real-estate developer transfers the realized commission payment.

27. The method of claim 23 wherein an owner of property involved in the real-estate transaction transfers the realized commission payment.

28. An online commission trading system comprising:
a communications network; and
a server coupled to the communication network configured to:
create an account for a real-estate agent;
purchase the expected commission payment from a real-estate agent in exchange for a payment of funds to the real-estate agent, wherein the expected commission payment is associated with a real-estate transaction; and
transfer funds to the real-estate agent in exchange for the expected commission payment, wherein the real-estate agent's right to the funds is not conditioned on completion of the real-estate transaction.

29. The online commission trading system of claim 28 wherein the server is further configured to:
receive information associated with the real-estate transaction; and
calculate a commission purchase price before purchasing the expected commission payment calculate a commission purchase price before the expected commission payment is purchased.

30. The online commission trading system of claim 28 wherein the server is further configured to receive a realized commission payment after the real-estate transaction is completed.

31. The online commission trading system of claim 28 wherein the server is further configured to provide status messages related to the sale of the expected commission payment.

32. The online commission trading system of claim 30 wherein the server is configured to receive the realized commission payment from an owner of property involved in the real-estate transaction.

33. The online commission trading system of claim 30 wherein the server is configured to receive the realized commission payment from the real-estate brokerage firm.

34. A machine implemented method for trading commissions online comprising:
creating an account for a real-estate brokerage firm;
purchasing an expected commission payment from the real-estate brokerage firm in exchange for a payment of funds to the real-estate brokerage firm, wherein the expected commission payment is associated with a real-estate transaction; and
transferring funds to the real-estate brokerage firm in exchange for the expected commission payment, wherein the real-estate brokerage firm's right to the funds is not conditioned on completion of the real-estate transaction.

35. The method of claim 34 further comprising:
receiving information associated with the real-estate transaction; and
calculating a commission purchase price before purchasing the expected commission payment.

36. The method of claim 34 wherein the commission purchase price is based on a discount cash flow model.

37. The method of claim 34 further comprising receiving a realized commission payment after the real-estate transaction is completed.

38. The method of claim 37 wherein the real-estate brokerage firm transfers the realized commission payment.

39. The method of claim 37 wherein an owner of property involved in the real-estate transaction transfers the realized commission payment.

40. The method of claim 37 wherein a real-estate developer transfers the realized commission payment.
